(19) United States
(12) Patent Application Publication
(10) Pub. No.: US 2009/0255368 A1
(43) Pub. Date: Oct. 15, 2009

(54) Torsional Vibration Damper

(75) Inventors: Wolfgang KIENER, Berlin (DE); Jens HERRMANN, Berlin (DE); Uwe FRANKE, Berlin (DE)

Correspondence Address: CROWELL & MORING LLP;INTELLECTUAL PROPERTY GROUP, P.O. BOX 14300, WASHINGTON, DC, 20044-4300, US

(73) Assignee: Hasse & Wrede GmbH, Berlin (DE)

(21) Appl. No.: 12/429,625

(22) Filed: Apr. 24, 2009

Related U.S. Application Data
(63) Continuation of application No. PCT/EP2007/009257, filed on Oct. 25, 2007.

(30) Foreign Application Priority Data
Oct. 26, 2006 (DE) 10 2006 050 520.4

(51) Int. Cl. F16F 15/16; F16F 15/14

(52) U.S. Cl. 74/573.12; 74/574.4

(57) ABSTRACT

A torsional vibration damper is described for damping torsional vibrations of a shaft, in particular, of the crankshaft of a reciprocating engine, having a housing which is connected to the shaft and has a closed, annular receiving chamber for receiving a flywheel ring and a highly viscous fluid, wherein the flywheel ring is coupled to the housing via spring elements. Here, the characteristic is determined firstly by the shearing forces of the highly viscous fluid, in particular, the silicone oil, in the gap spaces and secondly by the spring characteristic or rigidity of the resilient supporting ring. The flywheel ring is mounted circumferentially on an elastic supporting ring, which is connected to the housing. Alternatively, a torsional vibration damper may have the flywheel ring mounted on the inside on a rotationally elastic axial bearing.

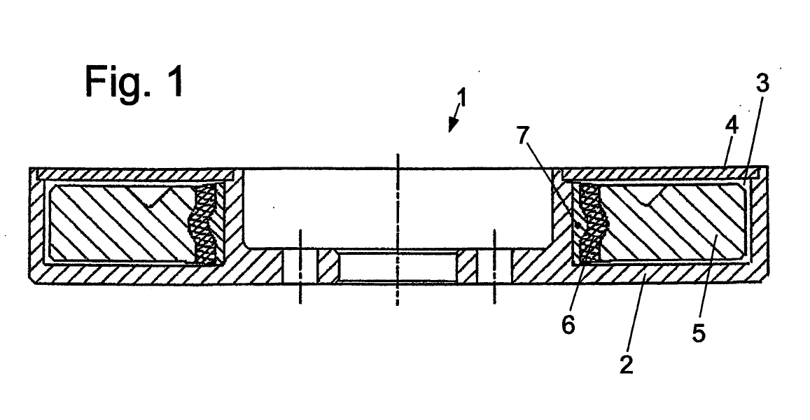

### CROSS-REFERENCE TO RELATED APPLICATIONS

This application is a continuation of PCT International Application No. PCT/EP2007/009257, filed Oct. 25, 2007, which claims priority under 35 U.S.C. § 119 to German Patent Application No. DE 10 2006 050 520.4, filed Oct. 26, 2006, the entire disclosures of which are herein expressly incorporated by reference.

### BACKGROUND AND SUMMARY OF THE INVENTION

The present invention relates to a torsional vibration damper for the damping of torsional vibrations of a shaft, in particular of the crankshaft of a reciprocating engine, with a housing connected to the shaft and having a closed annular reception chamber for receiving a flywheel ring and a high-viscosity fluid. The flywheel ring is coupled to the housing via spring elements.

Torsional vibration dampers are known in which the flywheel ring is coupled to the housing within the reception chamber solely via the high-viscosity fluid, preferably a silicone oil. The behavior of a torsional vibration damper of this type depends very much on the excitation frequency and on the operating temperature.

In order to achieve, overall, an equalization of the properties, designs are known in which the flywheel ring is ultimately coupled spring-elastically to the housing. By way of this additional coupling, the designer can influence the desired damping behavior more accurately than is possible when only high-viscosity fluids are used for coupling between the flywheel and housing.

Comparatively complicated solutions have hitherto been implemented with respect to generic torsional vibration dampers.

U.S. Pat. No. 3,495,459 discloses a torsional vibration damper, in which the flywheel ring is surrounded on the inside and, if appropriate, also on the outside by additional ring elements consisting of elastomeric materials. In U.S. Pat. No. 3,495,459, however, the flywheel ring is not mounted on the additional rings, and, furthermore, the additional rings are also not coupled to the housing.

The object on which the present invention is based is to provide a torsional vibration damper having an extremely simple structural set-up and which can consequently be manufactured cost-effectively.

This and other objects are achieved, according to the invention, by providing a torsional vibration damper for the damping of torsional vibrations of a shaft, in particular of the crankshaft of a reciprocating engine. A housing is connected to the shaft and has a closed annular reception chamber for receiving a flywheel ring and a high-viscosity fluid. The flywheel ring is coupled to the housing via spring elements. The flywheel ring is mounted circumferentially on an elastic supporting ring connected to the housing.

In a further embodiment for achieving the objectives, the flywheel ring is interiorly mounted on a torsionally elastic axial bearing connected to the housing.

In both embodiments, a simple and cost-effective design is implemented, since, in the first-mentioned embodiment, only one supporting ring consisting of elastic material is required in order to bring about a further coupling of the flywheel ring to the housing. An additional bearing may be dispensed with in this solution. In the second-mentioned embodiment, a suitable torsionally elastic axial bearing may be used, a supporting ring then, of course, is no longer required in this solution.

The supporting ring may couple the flywheel ring to the housing on the outside or on the inside. The supporting ring is preferably produced from an elastomeric material. Simple and cost-effective assembly is obtained by connecting the supporting ring non-positively and/or positively to the housing. In this case, advantageously, the supporting ring may be pressed into the housing.

Other objects, advantages and novel features of the present invention will become apparent from the following detailed description of one or more preferred embodiments when considered in conjunction with the accompanying drawings.

### BRIEF DESCRIPTION OF THE DRAWING

The single FIGURE is a section view through a torsional vibration damper according to the invention.

### DETAILED DESCRIPTION OF THE DRAWING

Referring to the FIGURE, reference symbol 1 designates the torsional vibration damper as a whole. The torsional vibration damper 1 has essentially an annular housing 2 with a likewise annular reception chamber 3, which can be closed sealingly by way of a cover 4.

Within the reception chamber 3 is provided a flywheel ring 5, which is mounted on its inner side on an elastic supporting ring 6. The supporting ring 6 consists of an elastic material and, in turn, is fastened to the housing 2.

The cross section of the flywheel ring 5 is somewhat smaller than the cross section of the reception chamber 3, so as to form between the flywheel ring 5 and the inner sides of the reception chamber 3 gap spaces into which a high-viscosity fluid, in particular a silicone oil, is introduced.

The torsional vibration damper 1 is fastened, overall, on a shaft, in particular on a crankshaft of a reciprocating engine, and, by virtue of the design described, is capable of damping torsional vibrations. In this case, the characteristic of the torsional vibration damper according to the present invention is determined, on the one hand, by the shear forces of the high-viscosity fluid, in particular of the silicone oil, in the gap spaces and, on the other hand, by the spring characteristic or rigidity of the spring-elastic supporting ring 6.

A system of this type is less susceptible to different excitation frequencies or different operating temperatures.

It is also contemplated to provide the supporting ring 6 on the outside of the flywheel ring 5, instead of arranging it on the inside of the flywheel ring 5, as illustrated in the exemplary embodiment.

A particularly advantageous possibility for mounting the supporting ring 6 is afforded in that this supporting ring 6 is fixed to a carrying ring 7, which is pressed into the housing 2 before the reception chamber 3 is finally closed by way of the cover 4. The supporting ring 6 is advantageously produced from an elastomeric material.

In the design described, further bearing elements for the flywheel ring 5 may be dispensed with. In an alternative embodiment to the exemplary embodiment illustrated, the flywheel ring 5 is mounted on the inside on a torsionally elastic axial bearing, in which case both the supporting ring 6 consisting of an elastomer and the carrying ring 7 may be dispensed with.

Both design variants offer the advantages already mentioned above, which are to be seen in that the damping behavior of the torsional vibration damper 1 is largely independent of the respective excitation frequency and also of the respective operating temperature.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A torsional vibration damper for damping torsional vibrations of a shaft, the torsional vibration damper comprising:
a housing connectable to the shaft, said housing have a closed annular reception chamber;
a flywheel ring and a high-viscosity fluid arranged in the closed annular reception chamber; and
an elastic supporting ring on which the flywheel ring is circumferentially mounted, the elastic supporting ring being connected to the housing.

2. The torsional vibration damper according to claim 1, wherein the shaft is a crankshaft of a reciprocating engine.

3. The torsional vibration damper according to claim 1, wherein an inner side of the flywheel ring is mounted on an outer side of the supporting ring.

4. The torsional vibration damper according to claim 1, wherein an outer side of the flywheel ring is mounted on an inner side of the elastic supporting ring.

5. The torsional vibration damper according to claim 1, wherein the elastic supporting ring consists essentially of an elastomeric material.

6. The torsional vibration damper according to claim 2, wherein the elastic supporting ring consists essentially of an elastomeric material.

7. The torsional vibration damper according to claim 3, wherein the elastic supporting ring consists essentially of an elastomeric material.

8. The torsional vibration damper according to claim 4, wherein the elastic supporting ring consists essentially of an elastomeric material.

9. The torsional vibration damper according to claim 1, further comprising a carrying ring on which the supporting ring is mounted, the carrying ring being pressed into the housing to connect the elastic supporting ring to the housing.

10. A torsional vibration damper for damping torsional vibrations of a shaft, the torsional vibration damper comprising:
a housing connectable to the shaft, the housing having a closed annular reception chamber;
a flywheel ring and a high-viscosity fluid arranged in the closed annular reception chamber; and
a torsionally elastic axial bearing on which an inner side of the flywheel ring is mounted.

11. The torsional vibration damper according to claim 10, wherein the shaft is a crankshaft of a reciprocating engine.

12. The torsional vibration damper according to claim 10, wherein the torsionally elastic axially bearing is pressed into the housing.
